(19) United States
(12) Patent Application Publication
(10) Pub. No.: US 2018/0149559 A1
(43) Pub. Date: May 31, 2018

(54) Sampling Point Assembly

(71) Applicant: Xtralis Global, Dublin 4 (IE)

(72) Inventor: Alasdair James Williamson, Worthing, Sussex (GB)

(21) Appl. No.: 15/551,744

(22) PCT Filed: Feb. 17, 2016
(86) PCT No.: PCT/EP2016/053329

§ 371 Date: Oct. 31, 2017

(30) Foreign Application Priority Data
Feb. 17, 2015 (AU) 2015900533

(51) Int. Cl. G01N 1/22

(52) U.S. Cl. CPC G01N 1/2273; G01N 2001/2285

(57) ABSTRACT

A sampling point assembly for an aspirating particle detection system is described. The sampling point assembly is configured to be mounted to a mounting structure associated with a volume to be sampled, the sampling point assembly being further configured to be coupled to a conduit to deliver an air sample from the volume being sampled to the conduit, the sampling point assembling including removable cartridge carrying an elastomeric valve mounted to a sampling point body.

### FIELD OF THE INVENTION

The present invention relates to a sampling point assembly for use in an aspirating particle detection system.

### BACKGROUND OF THE INVENTION

In aspirating particle detection systems, such as those that use the Vesda® range of smoke detectors manufactured by Xtralis Pty Ltd, a network of sampling pipes is routed over an area to be monitored by the particle detection system.

There are two primary types of pipe networks:
Systems in which a sampling pipe (or network of sampling pipes) includes a plurality of air sampling points. The sampling points may be directly connected to the pipe or connected by a second pipe, called a “sampling conduit” in this document. The sampling conduit is typically a length of flexible pipe of a narrower diameter than the sampling pipe, although this is not essential.
Systems in which sampling points are connected to the particle detector directly without any intervening shared length of sampling pipe. In such systems the sampling point is typically connected to the detector via a dedicated sampling conduit, which may be a length of flexible pipe as discussed above. In such systems a plurality of sampling points can be connected to a particle detector having multiple sample inlets. One example system of this type is an ICAM IFT-15 smoke detector from Xtralis Pty Ltd.

In their simplest form, sampling points may be a hole in a sampling pipe, open end of a conduit; but may also be a fitting that has an opening though which air is drawn. Such fittings typically take the form of a hollow generally cylindrical body with a frusto-conical tip having a hole at its end, into which air is drawn. The fitting will usually be mounted to a structure that positions the opening of the sampling point in the air (volume from which air is to be sampled e.g. a room, cabinet, AC duct. As noted above the fittings can be directly connected to an air sampling pipes, e.g. by being interposed in the pipe or attached to a T-junction directly, or connected to the sampling pipe, detector, or valve block etc. by a sampling conduit.

In the abovementioned systems an aspirator delivers sample air drawn from the ambient air in the sample location or volume (e.g. room or cabinet etc.) that is being monitored to the detector at a known flow rate. As will be appreciated the flow rate will vary depending on system parameters, but will typically be in the range of 10 to 150 litres per minute.

In order to ensure correct operation of the system, maintenance of the sample pipe network and sampling points is required. During this maintenance it is necessary to rectify any blockages of sampling holes or sampling pipes. In general this is a manual process undertaken by a technician and can be quite time consuming, and hence costly. During maintenance access to the sampling points or pipes may be required from either within the sample location or from a neighbouring space in which the sampling pipe is located, such as within the ceiling space above the sample location.

During installation the sampling point can be installed in or mounted to a surface of a mounting structure, such as a ceiling, floor or wall panel, or equipment cabinet panel. Preferably, installation would be able to be performed without removal of the mounting structure or access to a neighbouring space that lies on a second side of the structure, e.g. such as a ceiling space (above a room to be sampled) in which a sample pipe and other services may be located. This makes installation more straightforward for technicians as access to the neighbouring space is not needed.

It is therefore desirable to provide a sampling point assembly that is simple to install and remove.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF THE INVENTION

According to a first aspect, the present invention provides a sampling point assembly for an aspirating particle detection system, the sampling point assembly being configured to be mounted to a mounting structure associated with a volume to be sampled, the mounting structure comprising a panel-like portion having a first side and a second side and a space passing through the panel-like portion between the first side and second side that is able to receive the sampling point assembly, and at least the first side of the panel-like portion being exposed to the volume, the sampling point assembly being further configured to be coupled to a conduit to deliver an air sample from the volume being sampled to the conduit, the sampling point assembly including:

a sampling point body having a bore running from an inlet at a first end of the bore to an outlet at a second end of the bore, said inlet being configured to be maintained in fluid communication with the volume being sampled to receive an air sample therethrough, and said outlet being configured to be coupled to the conduit such that the air sample can pass through the bore to the conduit; and

fastening mechanism for securing the sampling point body to the mounting structure, said fastening mechanism including at least one mounting surface arranged in use to support the sampling point assembly on the first side of the mounting structure, and at least one fastening actuator for holding the surface against the mounting structure from the first side, said fastening actuator being operable from the first side of the mounting structure.

The fastening actuator can include an elongate finger that extends beyond the first side of the mounting structure that can be pulled from the first side to operate the fastening mechanism. The finger is preferably coupled to a clamping arm that is pulled against a second side of the mounting structure by pulling the finger.

The fastening mechanism can include a plurality of fastening actuators and corresponding clamping arms arranged around the sampling point body.

Said mounting surface(s) can be formed on a flange that, in use, abuts the mounting structure. The clamping arm can be held in place relative to the flange by a retaining mechanism. The retaining mechanism may include a ratchet.

The ratchet can comprise a rack and pawl arrangement, one of the rack or pawl being fixed with respect to the clamping arm and the other being fixed with respect to the mounting surface.

The fastening mechanism can include a fastening body that includes the mounting surface(s). The fastening body may also include one of the rack and pawl. In a preferred form the fastening body includes a receiving aperture extending though it and through which the finger of the fastening actuator passes. Adjacent the aperture may be mounted one of the rack and pawl of the retaining mechanism.

The fastening actuator can be of unitary construction and contain the finger and clamping arm integrally formed in a common body.

The fastening body may be separable from the sampling point body. In this case, preferably, the fastening body is generally annular and has a central void. The central void can be adapted to receive the sampling point body. The fastening body can have a plurality of fastening actuators and corresponding clamping arms arranged around the void.

According to a second aspect, the present invention provides a sampling point assembly for an aspirating particle detection system, the sampling point assembly being configured to be mounted to a mounting structure associated with a volume to be sampled, the sampling point assembly being further configured to be coupled to a conduit to deliver an air sample from the volume being sampled to the conduit, the sampling point assembling including:

a sampling point body having a bore running from an inlet at a first end of the bore to an outlet at a second end of the bore, said inlet being configured to be maintained in fluid communication with the volume being sampled to receive an air sample therethrough, and said outlet being configured to be coupled to the conduit such that the air sample can pass through the bore to the conduit; and

an elastomeric valve mounted to the sampling point body to determine the flow characteristics of sampling point.

The valve can be mounted outside the inlet, or within the bore. Preferably the valve abuts the inlet. The valve can be held in place by a cap or other retaining structure. The cap or retaining structure can also hold a filter in some embodiments.

In a preferred embodiment the elastomeric valve is carried in a removable cartridge. Preferably the cartridge also includes an orifice defining a flow restriction provided by the cartridge. The orifice can provide the inlet to the bore. The orifice thereby can be used to define the flow rate through the sampling point in use. In particularly preferred embodiments the cartridge is removable. Most preferable the cartridge is mounted so that it is readily removable from the sampling point body to enable it to be cleaned or replaced entirely. This facilitates maintenance of the sampling point.

According to a third aspect, the present invention provides a sampling point assembly for an aspirating particle detection system, the sampling point assembly being configured to be mounted to a mounting structure associated with a volume to be sampled, the sampling point assembly being further configured to be coupled to a conduit to deliver an air sample from the volume being sampled to the conduit, the sampling point assembling including:

a sampling point body having a bore running from an inlet at a first end of the bore to an outlet at a second end of the bore, said inlet being configured to be maintained in fluid communication with the volume being sampled to receive an air sample therethrough, and said outlet being configured to be coupled to the conduit such that the air sample can pass through the bore to the conduit; and

the sampling point body including a joint about which the body may be articulated to change the relative orientation of the inlet and outlet of the bore.

Preferably the sampling point body is formed in at least two parts, a first part at the inlet-end, and a second part at the outlet end. The first and second parts can be connected through the joint. Preferably the joint enables relative rotation of the first and second parts about an axis that is tilted from a longitudinal axis of the sample point body to enable relative re-orientation of the inlet and outlet of the bore. The longitudinal axis of the bore can be defined an axis parallel to the central axis of the inlet.

According to a fourth aspect, the present invention provides a sampling point assembly for an aspirating particle detection system, the sampling point assembly being configured to be mounted to a mounting structure associated with a volume to be sampled, the sampling point assembly being further configured to be coupled to a conduit to deliver an air sample from the volume being sampled to the conduit, the sampling point assembling including:

a sampling point body having a bore running from an inlet at a first end of the bore to an outlet at a second end of the bore, said inlet being configured to be maintained in fluid communication with the volume being sampled to receive an air sample therethrough, and said outlet being configured to be coupled to the conduit such that the air sample can pass through the bore to the conduit; and

a removable cartridge carrying an elastomeric valve mounted to the sampling point body.

Preferably the cartridge also includes an orifice defining a flow restriction provided by the cartridge. The orifice can define the inlet. The orifice thereby can be used to define the flow rate through the sampling point in use. In particularly preferred embodiments the cartridge is mounted so that it is readily removable from the sampling point body to enable it to be cleaned or replaced entirely. This facilitates maintenance of the sampling point.

The sampling point assemblies of the above aspects can further include a cap mounted with respect to the sampling point body such that it extends over the fastening mechanism to conceal the fastening mechanism from view from the first side of the mounting structure. The cap can form part of, or be integral with, the removable cartridge in some embodiments.

The cap is preferably removable to provide access to the fastening mechanism. The cap may have a surface on its outer side that is used to display text and/or graphics, for example a company logo, name, message or warning, or the like.

The text and/or graphics may be moulded, e.g. either embossed or impressed, in the cap. Alternatively, it can be provided as a sticker or directly printed on the cap. Other mechanisms for displaying text or graphics may be used.

The sampling point assemblies of the above aspects can further include a pre-filter. Preferably the pre-filter is mounted between the cap and inlet to the bore.

The sampling point assemblies of the above aspects can further include a pipe connection fitting mounted at the outlet through which a sampling conduit can be connected to the sampling point body and be in fluid communication to the bore. Preferably the pipe connection fitting is a push to release pipe connection fitting, such as a Carstick cartridge or the like.

The sampling point assemblies of the second, third and fourth embodiments can include a fastening mechanism. The fastening mechanism can be of the type described in connection with any embodiment of the first aspect of the present invention, or simply be one or more screws.

The sampling point assemblies of the second, third and fourth embodiments can have its sampling point body mounted to a first side of a surface of the mounting structure associated with the volume to be sampled, wherein the first side being the side exposed to the volume to be sampled.

In another form, the sampling point body may extend through a surface of the mounting structure associated with the volume to the sampled.

In a fifth aspect the present invention provides a removable cartridge for a sampling point assembly, said cartridge including:

an airflow path through the cartridge;

a mounting structure to enable the cartridge to be mounted to another component of a sampling point assembly, e.g. a sampling point body;

an elastomeric valve for controlling airflow through the cartridge.

Preferably the cartridge also includes an orifice defining a flow restriction provided by the cartridge. In use the orifice can act as an inlet of the sampling point assembly. The orifice thereby can be used to define the flow rate through the sampling point in use.

The removable cartridge can include one or more of;

a cartridge body for carrying the elastomeric valve;

an orifice member through which the orifice passes; and

an outer cap component covering an inlet to the flow path through the removable cartridge.

The cartridge body can carry the mounting structure. Preferably this is a first part of a mechanical mounting mechanism, which in use engages with a compatible mounting mechanism on another component of the sampling point body.

The cartridge body can include a flange that performs the function of the cap (preferably the outer cap) in other embodiments described herein.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

In order that the invention may be more fully understood, one embodiment will now be described by way of example, with reference to the figures in which:

FIGS. 1A and 1B are schematic diagrams of an exemplary aspirated particle detection system;

FIGS. 2(a) and 2(b) show top and bottom perspective views respectively, of a sampling point body;

FIG. 3 shows an exploded perspective view of the sampling point body of FIG. 2;

FIG. 4 shows a cross-section through the sampling point body of FIG. 2;

FIG. 5 shows an exploded perspective view of a cap forming part of the sampling point assembly of FIG. 2;

FIG. 6 shows a plan view of central cap component of the cap of FIG. 5, from above;

FIG. 7 is a cross-section through the sampling point assembly directly mounted to a mounting structure according to a first mode of use;

FIGS. 8(a) and 8(b) illustrate top and bottom perspective views, respectively, of a fastening mechanism which may be used in accordance with an embodiment of the present invention.

FIG. 9 is an exploded view of the fastening mechanism of FIGS. 8(a) and 8(b);

FIG. 10 shows a cross-sectional view through fastening member used in the fastening mechanism;

FIGS. 11(a) to 11(d) illustrate the steps in installation of the fastening mechanism into a mounting structure;

FIG. 12(a) illustrates a stage in the coupling of a sampling point body as illustrated in FIG. 2 into fastening mechanism of FIGS. 8(a) and 8(b);

FIG. 12(b) is a cross-section view through the mounted sampling point body and fastening mechanism;

FIGS. 13(a) and 13(b) show a sampling point body with its outlet positioned in different orientations with respect to its inlet;

FIG. 14(a) show a diagram of another exemplary aspirated particle detection system comprising a removable cartridge;

FIG. 14(b) shows cross-sectional view of the aspirated particle detection system of FIG. 14(a) across line A-A;

FIG. 15(a) shows a diagram of yet another exemplary aspirated particle detection system comprising a removable cartridge;

FIG. 15(b) shows cross-sectional view of the aspirated particle detection system of FIG. 15(a) across line B-B;

FIG. 16 (a) shows a bottom plan view of the removable cartridge of FIGS. 14 and 15;

FIG. 16(b) shows an exploded view of the removable cartridge of FIGS. 14 and 15;

FIG. 16(c) shows an assembled view of the removable cartridge.

### DETAILED DESCRIPTION OF THE EMBODIMENTS

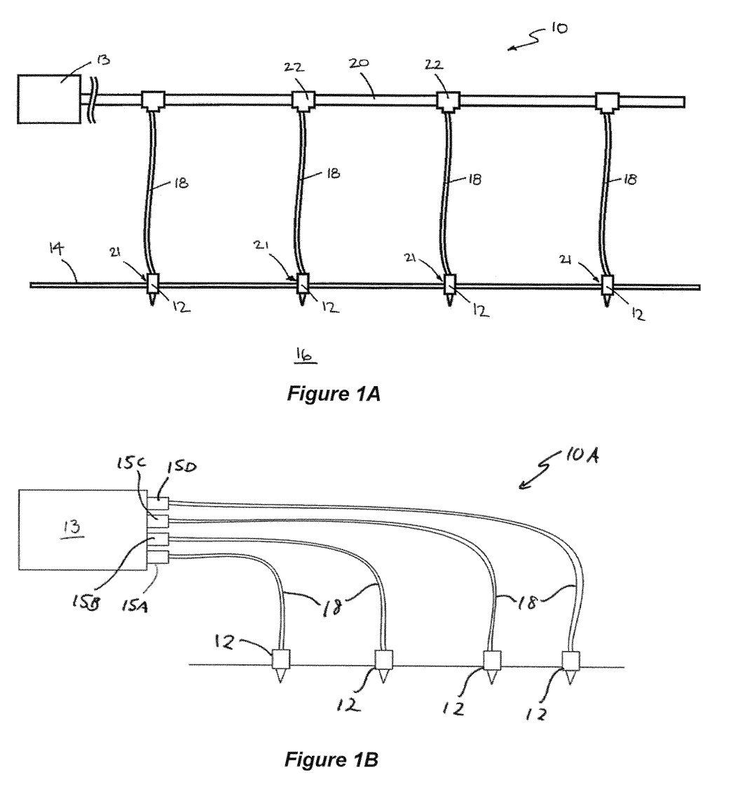

Exemplary embodiments of aspirating particle detection systems 10 and 10A are shown in FIGS. 1A and 1B. The system 10 is arranged to draw an air sample from a volume being monitored, e.g. room 16, and deliver the air sample to a particle detector 13 that may be a smoke detector. Sample air is drawn into the sampling points 12 and travels via sampling conduit 18 to a sampling pipe 20. The sampling conduits 18 are typically connected to the sampling pipe 20 via T-junctions 22. The sample air is drawn into the particle detector 13 for analysis.

There may be a number of such T-junctions 22 along a single length of sampling pipe 20, thereby providing a number of sampling points along a single length of sampling pipe 20. Furthermore, it will be appreciated that a number of sampling pipes 20 can be arranged, e.g. side by side to create a grid, or other geometry of sampling points.

The system is arranged such that the sampling pipe 20 is mounted above the ceiling 14 so and only the inlets of the sampling points 12 protrude through apertures 21 in a ceiling 14 to allow sample air to be drawn from within the room 16. In this way the only parts of the particle detection system that is visible from within the room are the sampling points 12.

FIG. 1B shows another exemplary particle detection system 10A. The system 10A is typical of microbore smoke detection systems and includes a smoke detector 13 having multiple inlets 15A, 15B, 150, 150. A sampling conduit 18 is connected to each inlet 15, 15A, 15B, 150, 15D. Each conduit 18 is also connected on its other end to a sampling point 12 that is mounted to a mounting structure e.g. a ceiling, equipment cabinet wall, or the like.

The present invention provides an improved sampling point assembly 30, which is able to be used as a sampling point 12 in the aspirating particle detector system 10 or 10A.

In the present description, orientations have been described with respect to the sampling point assembly 30 being fitted within a ceiling to draw an air sample from a room below the ceiling, however, it will be appreciated that sampling point assemblies can be fitted to other mounting structures, such as walls, cabinets, floors, to name but a few, and in other orientations. As will be appreciated, in the event of mounting in another orientation or surface the description of directions and positions e.g. upper surfaces would be correspondingly changed, e.g. to become side or rear surfaces etc. A person skilled in the art will understand the terminology used.

The exemplary embodiments are also described with reference to a particle detection system in which monitoring of sampled air is performed by an aspirating smoke detector. However, the particle detection system may be any type of air monitoring system or air sampling device that is be adapted to analyse and/or detect other characteristics or components of the air. For example the air monitoring system or sampling device may be a gas detector or other device capable of detecting the presence and/or concentration of one or more target gasses. An example of such an air sampling device is sold by Xtralis Technologies Ltd under the product name Vesda ECO.

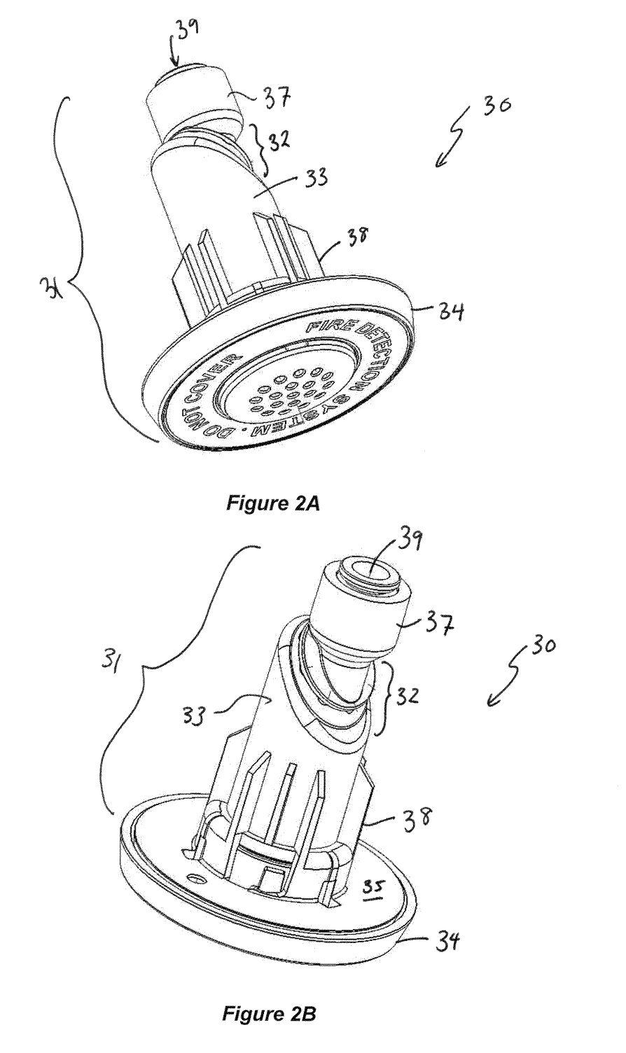

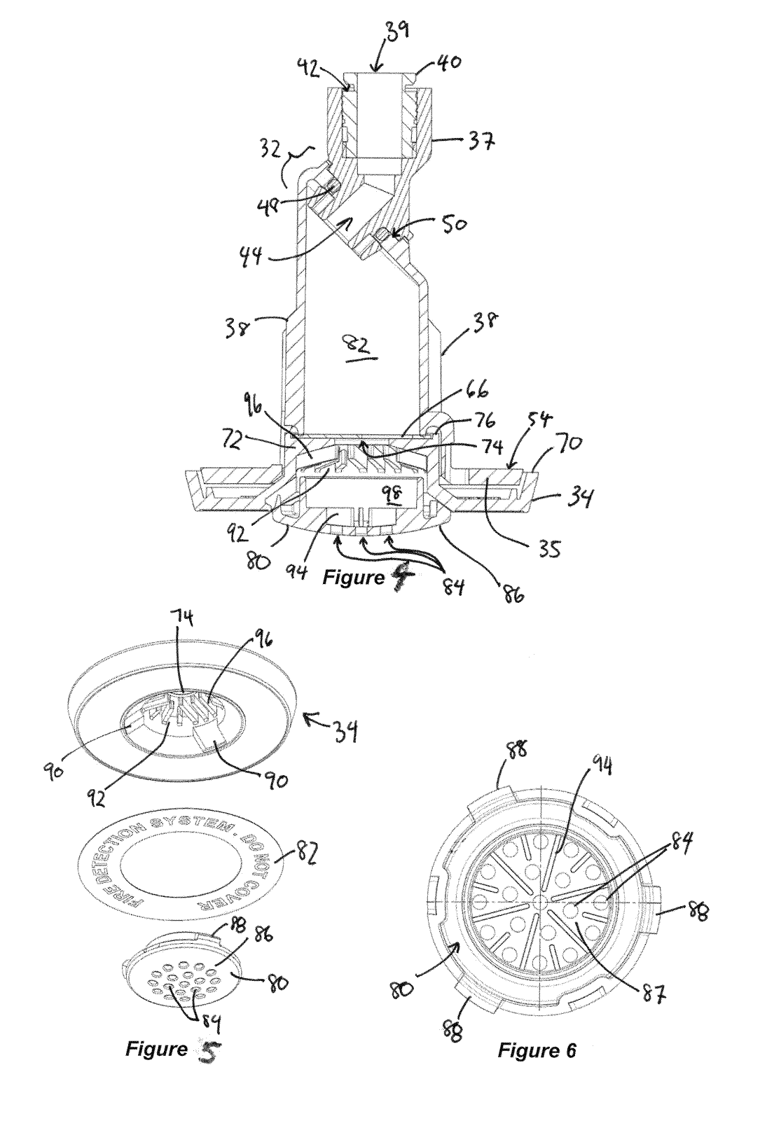

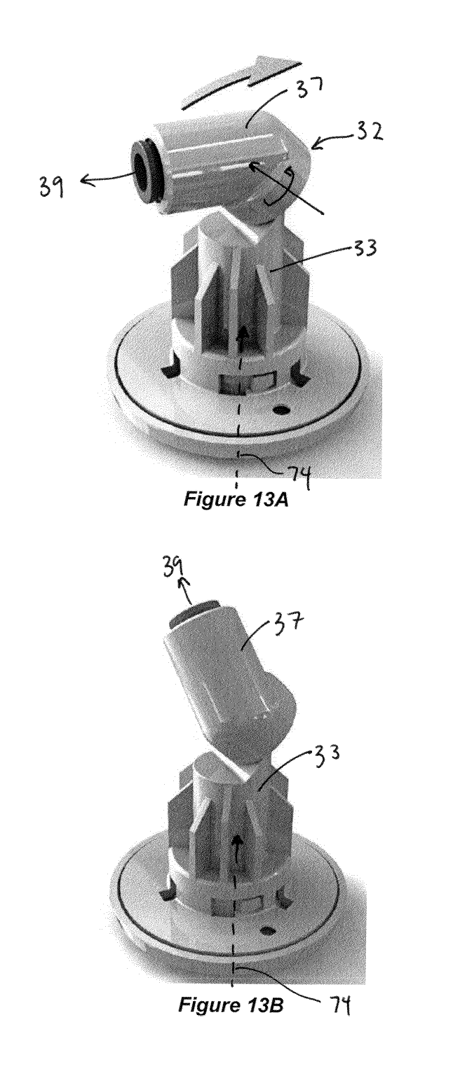

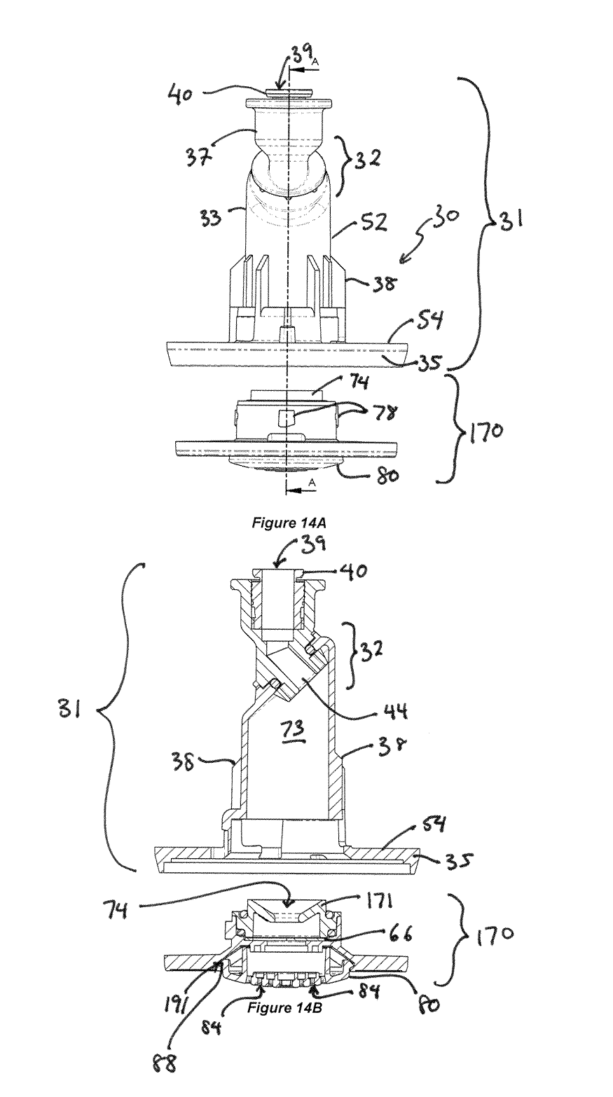

FIGS. 2(a) and 2(b) are bottom and top perspective views respectively of a sampling point assembly 30 in accordance with an aspect of the present invention. Sampling point assembly 30, generally includes a body 31 and a cap 34. The sampling point body 31 includes a generally tubular, lower body portion 33 which extends upwardly from a disk-shaped mounting flange 35. At the upper end of the sampling point body 31 is a second, upper, sampling point body portion 37 which includes an outlet 39. In use, the outlet 39 is connected to a sampling conduit 18 as mentioned above. The upper portion 37 and lower portion 33 of the sampling point body 31 are connected to each other by a rotatable connection 32. The rotatable connection 32 rotates about an axis offset at 45° from the longitudinal axis of the sampling point body 31. As illustrated in FIGS. 13(a) and (b) this rotatable connection 32 facilitates re-orientation of the outlet 39 with respect to the lower portion 33, of the sampling point body 31. At the lower portion 33 of the sampling point body the mounting flange 35 is provided with a cap 34. The cap 34 may include multiple components as described in connection with the FIGS. 5 and 6. The cap 34 has one or more holes 36 through which sample air is drawn into the sampling point assembly 30. The lower portion 33 of the sampling point body 31 includes a series of ribs 38 spaced around its circumference. The ribs 38 serve to strengthen sampling point body 31 by buttressing the lower portion 33 of the sampling point body 31. Together, the ribs 38 define the outer periphery of the lower portion 33 of the sampling point body 31, and in use, assist to locate and prevent lateral movement of the sampling point assembly 30 within an aperture in a mounting structure in which the sampling point body 31 will be fitted.

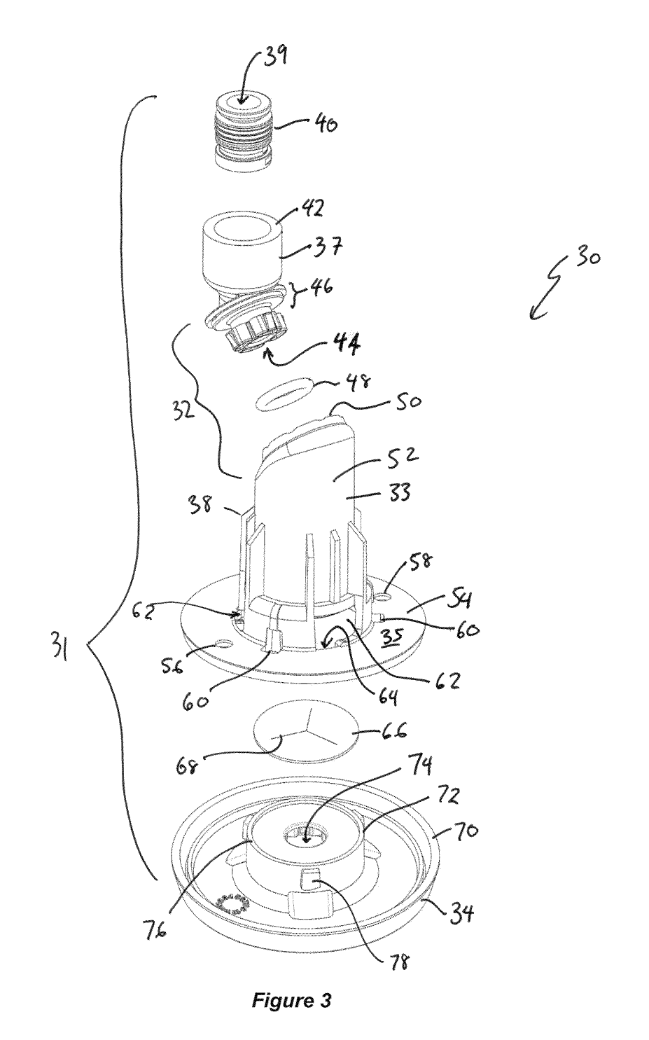

Further details of the sampling point assembly 30 can be seen in FIG. 3, which shows an exploded view of the assembly.

FIG. 3 illustrates an exploded view of the sampling point assembly 30. The sampling point assembly 30 includes a pipe fitting or coupling 40, which sits at the most downstream end of the sampling point body 31 and defines the outlet 39 of the sampling point assembly 30. The coupling 40 is typically a push to release, quick release fitting such as a Carstick cartridge or other like fitting. It is received into a downstream opening 42 in the upper portion 37 of the sampling point body 31. The upstream end of the upper portion 37, is an inlet 44 through which air flowing through the sampling point body 31 passes. A series of stepped flanges 46 are located just above the inlet 44 and with the top face 50 of the lower portion 33 form a joint 32 that connects the upper portion 37 and lower portion 33 of the sampling point body 31 together. This joint 32 is sealed by O-ring 48. The inlet 44 of the upper portion 37 of sampling point body is received into an opening (not shown) in the top end of the lower portion 33 of the sampling point body 31. As will be appreciated, the joint 32 illustrated in this example could be replaced by any other type of joint. However, in the preferred embodiment the joint enables articulation between the top and bottom portions 37 and 33 of the sampling point body 31 so that the inlet 74 and the outlet 39 can be reorientated with respect to each other. In use, this allows the sampling point body 31 to be reconfigured to better enable connection of the sampling conduit 18 to the outlet 39 by repositioning the outlet to a more convenient orientation. In order to enable reorientation, the plane of rotation of the two body portions 37 and 33 is tilted so that it is offset to the central axis of the inlet 74 to the sampling point body 31. When the sampling point body 31 is assembled, rotation about the angled face 50 and the flange 46 causes the outlet 39 to transcribe a cone which defines a range of angular offsets of the outlet 39 with respect to the direction of the bore at the inlet.

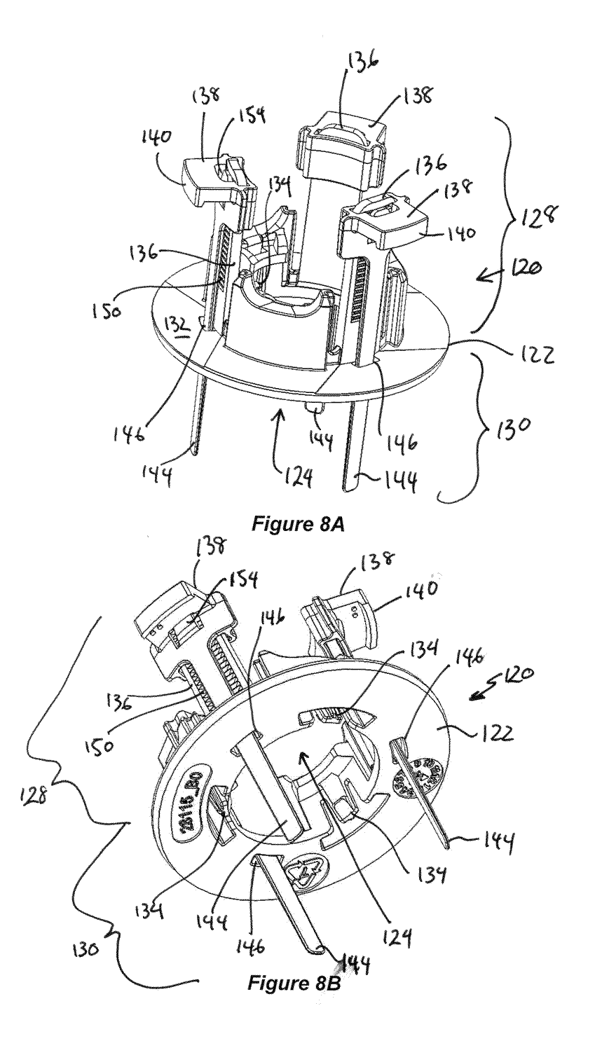

The lower part 33 of the sampling point body 31, as previously described, includes a series of ribs 38 which define a minimum size space, or hole into which the sampling body can be inserted for installation. They also support and strengthen the cylindrical main portion 52 of the lower portion 33 of the sampling point body 31. The mounting flange 35 has a generally flat upper surface 54. When the sampling point assembly 30 is mounted to a support structure, the mounting surface 54 abuts the surface of the mounting structure. One or more holes 56 and 58 are provided through the flange 35. The holes 56 and 58 can be used as screw holes through which screws can be inserted to secure sampling point body 31 to the mounting structure. As will be described below, the use of screws are optional in the preferred embodiment. In this regard, the present embodiment is also provided with mechanism for mounting the sampling point body 31 to the mounting structure via a fastening mechanism, which will be described in more detail in connection with FIGS. 8A to 13. The lower portion 33 of the sampling point body 31 also includes receiving apertures 60 through which fastening actuator of the fastening mechanism can project in a manner that will be described below. A hole 62 is also provided in the side wall of the lower most end of the cylindrical part 52 of the lower portion 33 of the sampling point body 31. This hole 62 in the present example forms part of a socket for a bayonet fitting that is used for mounting the cap 34. A groove or channel 64 is also provided through an inside edge of the annular flange 35. The channel 64 acts as a lead-in to the hole 62, to enable the male projection of the bayonet fitting to be received in to the hole 62. As would be appreciated, the hole 62 may be covered i.e. instead of being a hole that extends the whole way through the wall 52, the hole 62 can just be a recess or indentation on the inner side of the wall 52 to receive the other component of the bayonet fitting.

The sampling point assembly 30 is also provided with a valve 66. The valve 66 is effectively a diaphragm or disc of elastomeric material with a slit 68 cut through it to define flaps. When air pressure is applied to the valve 66 the slits will open in a pre-determined manner to allow air-flow therethrough. As will be appreciated, diaphragm valves of this type are well known and their air flow control properties can be chosen by one skilled in the art.

In the preferred embodiment, the valve 66 is provided so that the sampling point assembly 30 of the preferred embodiment can be used as the sampling point or accessory in an embodiment of one or more of the systems described in any one of:
International Patent Application No. PCT/AU2014/050290;
Australian Provisional Patent Application No. 2014901211; or
U.S. patent application 61/949,191.

For example the valve 66 can operate as a flow modulating device as described therein.

The cap 34 performs a function of covering fastening screws or components of the fastening mechanism (illustrated in other embodiments) and also retains the valve 66. The cap 34 is, broadly speaking, disc-shaped and includes a raised peripheral rim 70 and a generally cylindrical central hub 72. The hub 72 has a hole 74 which defines the inlet to the bore of the sampling point body 31. A small upstanding ring shaped flange 76 surrounds the top face of the hub 72, thereby defining a shallow recess in which the valve 66 sits. Around the edge of the hub 72 is a series of projections 78 which form the male component of the bayonet fitting that is used for attaching the cap 34 to the lower portion 33 of the sampling point body. Further details of the cap 34 will be described in connection with FIGS. 5 and 6.

FIG. 4 is a cross sectional view of the sampling point assembly 30. In addition to the components illustrated in FIG. 3, the cap 34 is additionally fitted with an inner cap 80, which is received into the underside of the hub 72. This cross-sectional view illustrates the flow path through the sampling point body 30 beginning at the inlet 74 progressing through valve 66 into the hollow bore 73 within the lower portion 33 of the sampling point body 31 and continuing through the inlet 44 in the joint portion 32 of the upper part 37 of the sampling point body 31 and up to the outlet 39.

Further details of the cap arrangement will now be described in connection with FIGS. 4, 5 and 6, FIG. 5 shows an exploded view of the cap arrangement including the outer cap component 34 and the inner cap component 80 and an optional label 82.

The label 82 in this example is used to indicate that the sampling point is part of a fire detection system. However, the cap arrangement can display any type of text and/or graphics.

The text and/or graphics may be positioned on a surface of the cap 34 or outer cap 80 so that it is visible when the cap is fitted, and the sampling point mounted to the mounting structure. The text or graphics may be moulded, e.g. either embossed or impressed, in a component(s) of the cap arrangement. Alternatively, the text may be provided as a sticker 82 (as in this case) or directly printed on the cap 34 or 80. Other mechanisms for permanently displaying text or graphics may be used.

A view of the top side of the cap 80 is illustrated in FIG. 6. The inner cap 80 is generally button like in shape and includes a series of small inlet holes 84 in its lower face 86. The holes 84 allow ambient air surrounding the sampling point to be drawn into the sampling point. The inner cap 80 additionally includes a series of resiliently deformable latches 88 set about its periphery. The latches 88 are received into respective notches 90 in the inside surface of the hub portion 72 of the outer cap 34. The inner face 87 of the inner cap 80 and the lower face 92 of the outer cap 34 both include a series of fins 94 and 96 respectively. The fins serve to define an advantageous airflow path of air toward the inlet 74. In some embodiments, a pre-filter (not shown) can be inserted in the inner cap 80 e.g. in void 98 to remove large sized nuisance particles such as dust and lint.

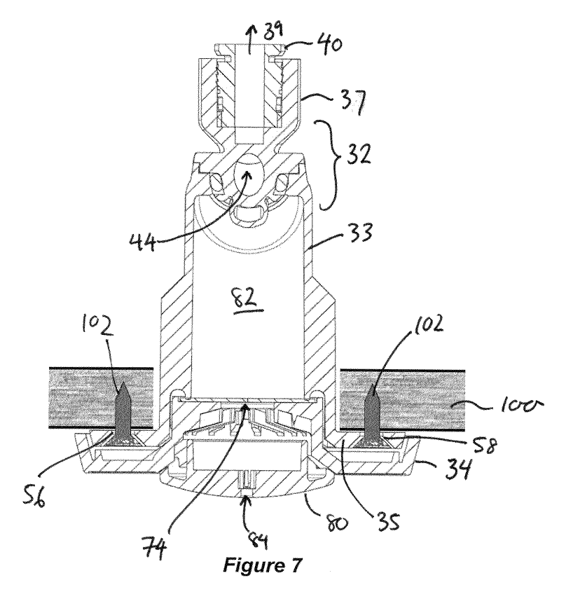

FIG. 7 illustrates another cross-sectional view through the sampling point assembly 30, which is orthogonal to the cross section shown in FIG. 4. In FIG. 7 however, the sampling point body 12 is shown mounted to a mounting structure 100. The mounting structure may be a ceiling board, such as a board of Sheetrock or foam sandwich material or the like. In this example, the sampling point assembly 30 is attached to the ceiling board via a pair of screws 102 which are inserted through the flange 35 through holes 56 and 58.

As will be appreciated, mounting the sampling point assembly 30 to the mounting structure 100 using screws is conventional and will be familiar to most installers. However, this mounting mechanism may not be secure, as the mounting structure may be made of light weight or highly friable material that is not well suited to receiving screws in it. The second embodiment described in FIG. 8 onward can assist in ameliorating this potential disadvantage.

To avoid confusion it should be noted that in the first embodiment the sampling point assembly 30 consisted entirely of the sampling point body 31 including its caps 34 and 80. In the example to follow the sampling point assembly 30 additionally includes a separate fastening mechanism 120. This two part construction forms an additional aspect of the present invention.

FIGS. 8A and 8B show top and bottom perspective views, respectively, of a fastening mechanism able to be used in some embodiments of the present invention. The fastening mechanism 120 comprises a fastening body 122 which is generally annular in shape and includes a central void 124. The void 124 provides an opening in the fastening body 122 into which a sampling point body can be inserted. The fastening mechanism 120 also includes a series (in this case three, but it may be more or less) of fastening actuators 126. The fastening actuators 126 extend through the fastening body 122 from its upper side 128 to its lower side 130. The portion of the fastening actuators 126 that extend above the upper side 128 of the fastening body 122 are arranged to operate as a clamp to hold the fastening body 122 to the mounting structure. The portions extend that below the fastening body 122 to underside 130 are used to operate the actuator to pull the clamp tight to hold the fastening body 122 in place.

Returning to the fastening body 122, which includes a mounting surface 132, which in use is positioned to abut a surface on a first side of the mounting structure to which the fastening body 122 will be attached. On the upper side 128 of the fastening body 122 there are also a series of locking arrangements 134 into which a sampling point body such as that described in FIGS. 1 to 6 can be received. The locking arrangements 134 can be biased, deformable arms which lock against the suitably positioned notch or ridge in the wall of the sampling point body to retain it. The fastening body 122 also includes three upstanding tongues 136 which form part of the retaining mechanism 151 which is used to lock the fastening actuators in position.

The actuators 126 each include clamping arm 138 which extends radially outward from the centre of the fastening mechanism 128. As can be seen, the outermost edge 140 of the clamping arm 138 overlies the mounting surface 132 of the fastening body 122, thus creating an F-clamp between them. In use, by tightening the fastening actuators the F-clamp formed between the clamping arm 138 and the mounting surface 132 can be used to secure the fastening mechanism 120 to the mounting structure. The fastening actuator 126 also includes a portion 142 of the retaining mechanism 151 which co-operates with the portion of locking mechanism that forms part of the tongue 136. Extending down from the clamping arm is an elongated finger 144. The finger 144 extends down through a corresponding receiving aperture 146, in the form of a hole 146 in the fastening body 122, such that the finger 144 extends below the underside 130 of the fastening body 122. In use, the fingers 144 can be pulled by a person installing the fastening mechanism 120 to cause the clamping arm 138 to be drawn down towards the mounting surface 132 to close the clamp formed between them.

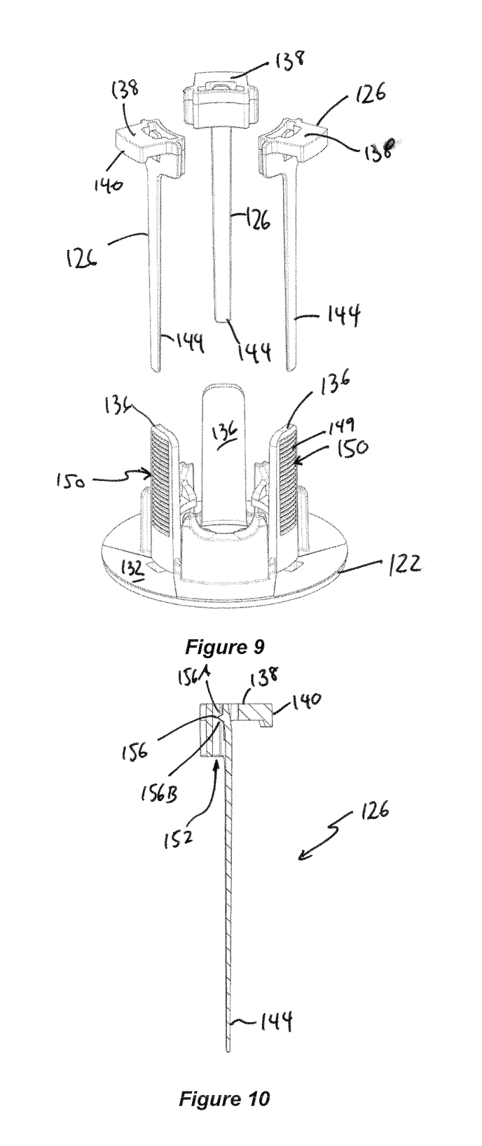

FIG. 9 shows an exploded view of the fastening mechanism 120 described in connection with FIGS. 8A and 8B. FIG. 9 shows more detail of the components 150 of the retaining mechanism that are formed into the tongues 136. In this example the tongues 136 have a series of ribs 149 which together form a gear rack 150. Gear rack 150 co-operates with a biased pawl which forms part of the fastening actuator 126 to provide a retaining mechanism for retaining fastening actuators 126 with respect to the fastening body 120. The cross-sectional view of the fastening actuator 126, shown in FIG. 10 illustrates the pawl 156 of the retaining mechanism in more detail. As can be seen in FIG. 10 the fastening actuator 126 is shaped like an inverted L. At its top part is located the clamping arm 138 and at its lower part the elongate finger 144. The retaining mechanism sits between them and in this example, comprises a slot 152 which is sized and shaped to receive a respective tongue 136 within it. The slot 152 guides the fastening actuator in its travel with respect to the tongue 136. One side of the slot possesses a slightly inwardly angled finger 154 which has, on its inner most side (when considered from the position of the slot 152) a projection 156. The triangular projection 156 acts as a pawl and locks into the notches between ribs 149 of the rack 150 on the tongue 136. The projection 156 is shaped as a non-equilateral triangle with the upper and lower sides of the projection 156 being set at different angles with respect to the direction of projection of the elongated member 154. By providing a steeper top surface 156A than the lower surface 156B the pawl is arranged to more easily allow tightening of the actuator than release of the actuator. Because the elongated member 154 is only fixed by its lower end, to the body of the fastening actuator 126, it is free to flex to enable movement of the pawl 156 past successive ridges in the rack 150. As will be appreciated, the fastening actuator 126 in this example will be formed of a plastics material which is resiliently deformable and the resilience of the plastics material is what provides the bias to the pawl of the ratchet mechanism. However, other constructions, e.g. using a metal pawl mechanism could be used. The retaining mechanism comprising the ratchet and pawl arrangement formed from the tongue 136 and finger 154 can be considered very similar to the components of a ratchet cable tie.

As will be appreciated by those skilled in the art, whether the ratchet or pawl is located on the fastening actuator or fastening body 122 is not important and the order of positioning can be changed from present embodiment. Moreover, different forms of retaining mechanism could be used in other embodiments.

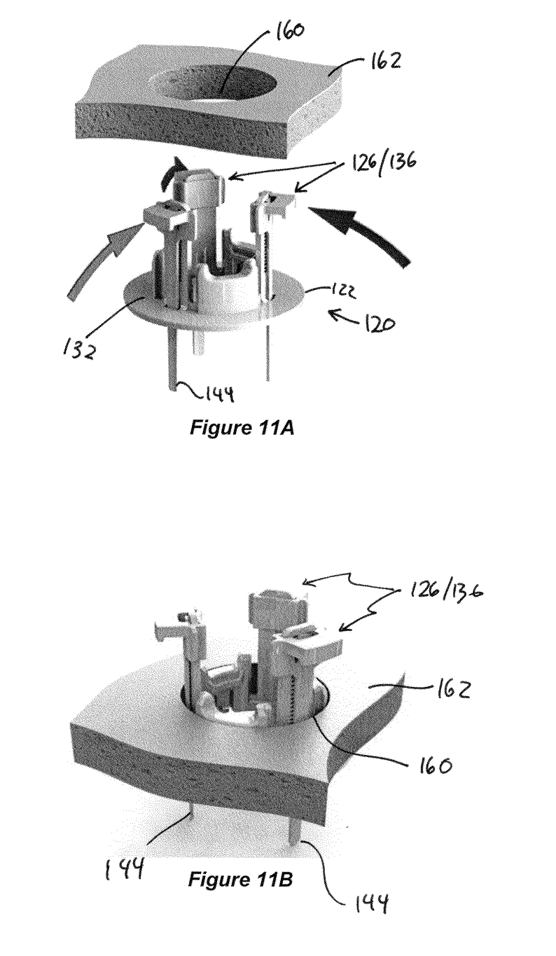

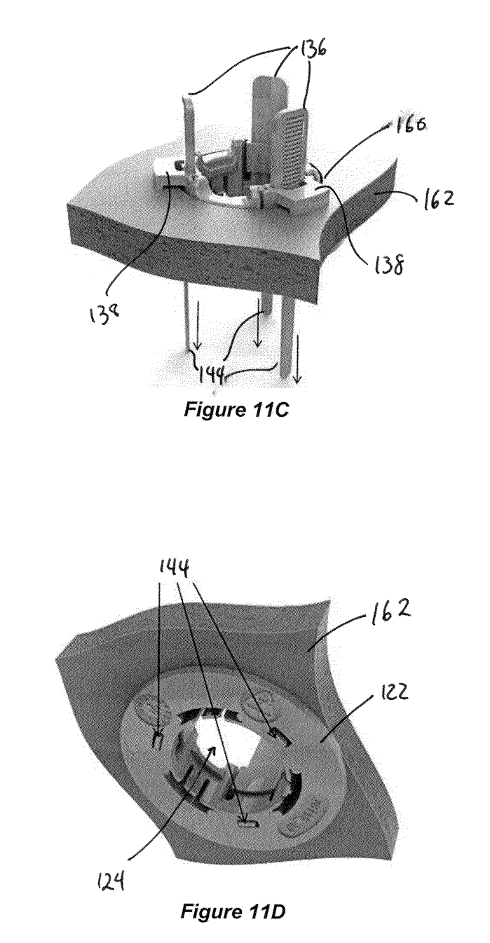

FIG. 11a illustrates an assembled fastening mechanism ready for installation in a hole 160 in a mounting structure 162.

As a first step in the installation process, the fastening actuators 126 are fitted to the fastening body 120 such that the retaining mechanism is either just engaged or loosely located without reaching its first retained position on the ratchet. In this condition, the distance between the jaws of the clamp formed between the clamping arm 138 and the mounting flange 132 is at its maximum. In order to insert the fastening mechanism 120 into the hole 160 the installer flexes each tongue and fastening actuator mounted to it radially inward so that the end 140 of each clamping arm clears the inside edge of the hole 160. Because the fastening mechanism is made from resilient, plastics material, after the deformation of the fastening actuator 126 and tongues 136, they spring back to their original position as shown in FIG. 11B.

As can be seen in this figure, the clamping arms 138 extend radially outward past the edge of the hole 160 such that the ends 140 of the clamping arms 138, when pulled down by operating the fastening actuator 126 will grip the upper surface of the mounting structure. FIG. 11C shows the fastening mechanism after the fastening actuators 126 have been operated to pull the clamping arms 138 down onto the mounting structure. This is performed by the installer gripping the respective fingers 144 of each fastening actuator 126 and pulling on them. This draws the clamping arm 138 downwards and clamps the fastening mechanism 120 onto the mounting structure.

As will be appreciated a version of the above described fastening mechanism could be incorporated directly into the sampling point body, without use of the separate fastening body. For example, this could be achieved by incorporating the features of the fastening mechanism directly into the flange 35 of the sampling point body 31.

FIG. 11D shows the completed mounting process. In FIG. 11D the protruding ends of the fastening actuators 126, i.e. the elongated fingers 144, have been removed, e.g. by trimming with a pair of side-cutters, breaking the elongated finger at a frangible point somewhere along its length.

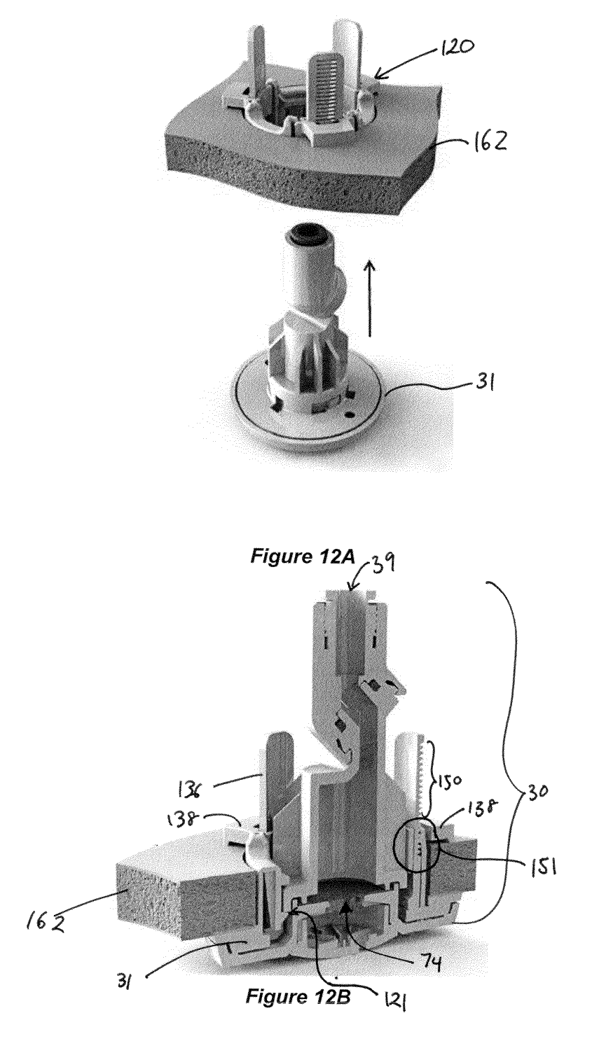

In the condition shown in FIG. 11D the fastening mechanism is configured to receive a sampling point assembly and to secure it to the mounting structure as illustrated in FIGS. 12A and 12B.

It should be noted that FIGS. 12A and 12B illustrate a slightly modified sampling point body to that shown in FIG. 2A. The modifications reside primarily in the joint mechanism illustrated in FIG. 12B.

As can be seen in FIG. 12B sampling point body 31 can be inserted up through the void 124 in the fastening mechanism 120. Typically, prior to installation of the sampling point body 31 into the fastening mechanism 120 the sampling conduit will be connected to the outlet 39 of the sampling point body 31. Alternatively, after mounting of the sampling point body the sampling conduit can be fitted to the outlet. However, it will be appreciated that in order to perform this alternate mounting procedure, access to the second side of the mounting assembly will be necessary. This may prove troublesome in some situations such as when the mounting structure is a ceiling panel and only a small ceiling space exists or there is no access to the ceiling space. Once the sampling point body 31 is fully inserted into the fastening mechanism 120 as shown in FIG. 12B, they are locked together by the locking mechanism 134. As can be seen in FIG. 12B, the locking mechanism 134 is a resilient arm that extends out under a downwardly facing flange 21 of the sampling point body 31 and locks it in place by being removed in a downward direction. FIG. 12B also clearly illustrates the retaining mechanism 151 in a locked position.

FIGS. 13A and 13B are provided for completeness, and illustrate how the outlet and inlet of the sampling point body can be re-orientated with respect to each other. FIG. 13A shows a situation in which the upper portion 37 of the sampling point body 31 has been rotated by 180° about the joint 32. Because of the tilted axis of rotation of the joint 32 the outlet 39 is angled at 90° to the inlet 74 to the sampling point body 31. This will be particularly useful in scenarios where either limited height is available above the sampling point body 31 during installation, or the sampling conduit to which the sampling point assembly 31 is connected arrives at the location of the sampling point assembly in a generally horizontal orientation. FIG. 13B illustrates an intermediate angle between that shown in FIG. 13A and all other figures in the present specification. This positioning of the upper part 37 of the sampling point body 31 has been achieved by rotating it with respect to the lower part 33 of the sampling point body 31 by an angle less than 180°.

FIG. 14A is a side on view of a sampling point assembly 30 in accordance with another embodiment of the present invention. FIG. 14B shows a cross sectional view of the sampling point assembly of FIG. 14A across line A-A.

The sampling point assembly 30 as shown in FIGS. 14A and 14B again comprises a sampling point body 31 such as that described above with reference to FIGS. 3-4, and a removable cartridge 170, which is configured to carry an elastomeric valve 66. In accordance with this embodiment of the invention, the removable cartridge 170 is configured to be mounted to the sampling point body 31 in use, but can be readily detached from the sampling point body 31 to enable the cartridge 170 and/or components of the removable cartridge 170 to be cleaned or replaced entirely for maintenance purposes or for any other reasons.

The removable cartridge 170 provides an airflow path which is in fluid communication with the bore 73 of the sampling point body 31 after the cartridge 170 is attached to the sampling point body 31. This allows the sample air to enter the sampling point for example from a lower end of the removable cartridge 170, travel through the bore 73, and then exit the sampling point body 31 from the outlet 39 of the sampling point body 31 to enter the sampling conduit. In one form, the sample air enters the airflow path of the cartridge 170 from a lower surface of the cartridge 170 via one or more inlet holes 84 of a removable cap component 80, similar to the embodiment described above with reference to FIGS. 4-6. Preferably the removable cartridge 170 comprises a flow restriction mechanism for controlling the flow rate of the sample air entering the bore 73. In one embodiment, the flow restriction mechanism is provided by an orifice member 171 which may be located at or near the outlet end of the removable cartridge 170, i.e. the flow restriction mechanism is located closer to the inlet end of the bore 73. The orifice member 171 restricts the air flow rate by providing a narrower or restricted air flow pathway. The valve member 66 is placed within the airflow path of the removable cartridge 170 and upstream of the flow restriction mechanism.

As mentioned above, the removable cartridge 170 is configured to be removably coupled or mounted to the sampling point body 31 in use, via a suitable mounting structure. The mounting structure may use a similar mounting mechanism such as that described above with reference to FIGS. 8a to 13, i.e. a bayonet fitting may be used for mounting the removable cartridge 170 to the sampling point body 31. The removable cartridge 170 may be detached from the sampling point 31 when a user rotates or twists the cartridge 170 relative to the sampling point body 31, to allow the male projection of the bayonet fitting to disengage from the receiving holes 62 located in the sampling point body 31.

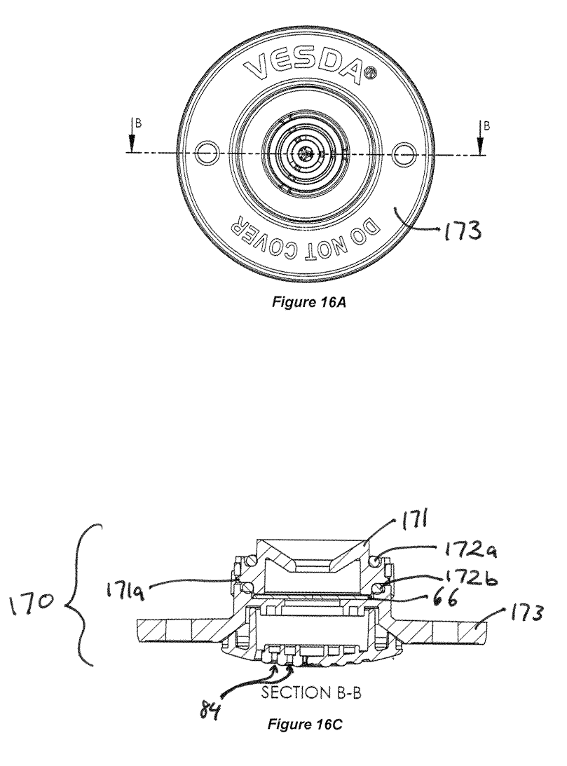

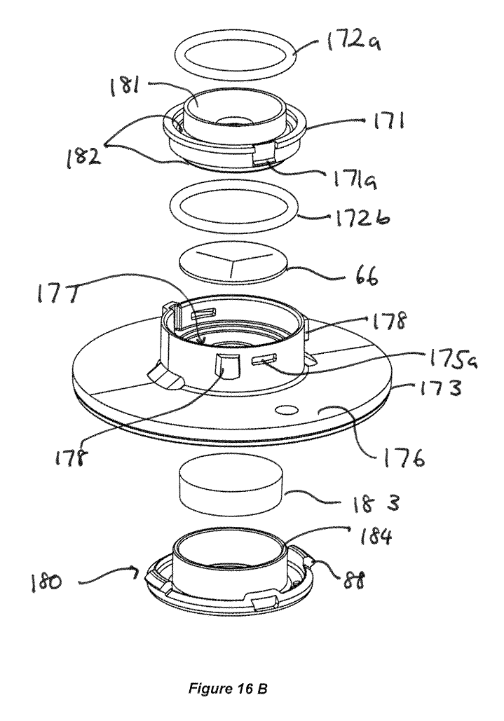

FIG. 16B shows an exploded view of the removable cartridge 170 of FIG. 14B. The removable cartridge 170 comprises at least a cartridge body 173 and an elastomeric valve 66 carried by the cartridge body 173. The cartridge body 173 comprises a mounting structure allowing the cartridge body 173 to be removably mounted to another component of a sampling point assembly, e.g. the sampling point body 31.

The cartridge body 173, broadly speaking, includes a generally cylindrical central hub 175 and a flange 176 extending radially outwardly from a lower periphery of the central hub 175. Preferably the valve 66 is accommodated within the cylindrical central hub 175. In a preferred embodiment, the hub 175 comprises a valve seat, or a recess to allow the valve 66 to be seated within the interior of the hub 175. In one form, the valve is supported by a ring shaped flange 177 extending radially inwardly from an interior of the hub 175, defining a recess in which the valve 66 sits.

As mentioned above, the cartridge body 173 comprises a mounting structure allowing the cartridge to be removably coupled to or mounted to a sampling point body 31. In one embodiment, the cartridge body 173 carries a first part of a mounting structure, which in use engages with a compatible, second part of the mounting structure on the sampling point body 31. As an example, around the edge of the hub 175 is a series of projections 178 which form the male component of the bayonet fitting that is used for attaching the removable cartridge 170 to the lower portion 33 of the sampling point body 31. Other mounting structures may be used as an alternative so long as it allows the cartridge body 173 to be removably mounted to the sampling point body 31.

As shown in FIG. 16a the under surface of the flange 176 may be used to display text and/or graphics, for example a company logo, name, message or warning, or the like. The top surface of the flange 176 abuts the mounting flange 35 of the sampling point body 31 after the cartridge 170 is removably mounted.

In the example shown, the removable cartridge 170 also comprises a cap component 180 for covering the inlet to the flow path of the removable cartridge 170. The cap component 180 is similar to the inner cap component 80 as described above with reference to FIGS. 5-6. The cap component 180 is received into the underside of the hub 175. The cap 180 is generally button like in shape and includes a series of small inlet holes 84 in its lower face allowing ambient air to be drawn into the air pathway of the removable cartridge 170. The cap component 180 additionally includes a series of resiliently deformable latches 88 set about its periphery. The latches 88 are received into respective notches 191 (shown best in FIG. 14B) in the inside surface of the hub portion 175 of the cartridge body 173.

The removable cartridge 170 may also carry an optional pre-filter 183 for removing larger particles. In the example shown in FIG. 16B, the cap component 180 comprises a hollow cylindrical portion 184 for accommodating the pre-filter 183.

In a preferred embodiment, the removable cartridge 170 includes an orifice 174 defining a flow restriction. In FIG. 16B, this orifice is provided by an orifice member 171, which is preferably located downstream of the elastomeric valve 66 in the air flow path of the removable cartridge 170. In use the orifice 174 can act as an inlet of the sampling point assembly. The orifice 174 thereby can be used to define the flow rate through the sampling point in use.

The orifice member 171 is of a generally hollow cylindrical shape. The interior of the orifice member 171 forms part of the flow path of the removable cartridge 170 and defines the flow restriction. A flange 181 extends radially inwardly and downwardly from an upper rim of the orifice member 171 which restricts the flow pathway of the removable cartridge 170.

In one form, the orifice member 171 is configured to be partially or fully inserted into the interior of the hub 175 of the cartridge body 170. As the orifice member 171 is at least partially or fully received within the hub 175, the exterior of the orifice member 171 is preferably profiled to receive additional sealing O-rings 172a and 172b to assist in sealing between the orifice member 171 and the hub 175. For example, the exterior of the orifice member 171 may comprise a circular channel or groove 182 for receiving a first sealing ring 172a, which assists in sealing between the cartridge 170 and the sampling point body 31. A second sealing ring 172b is provided between the orifice member 171 and the cartridge body 173. The orifice member 171 includes a plurality of latches 171a which are received into corresponding notches 175a in the hub's 175 wall to hold the orifice member 171 in place in the removable cartridge assembly 170. As can be seen the elastomeric valve 66 is held between the orifice member 171 and flange 177.

FIG. 160 shows a cross sectional view of the removable cartridge in its fully assembled form. The entire cartridge can be replaced or cleaned in its fully assembled form. Alternatively, one or more components of the cartridge 170 may be replaced and/or cleaned.

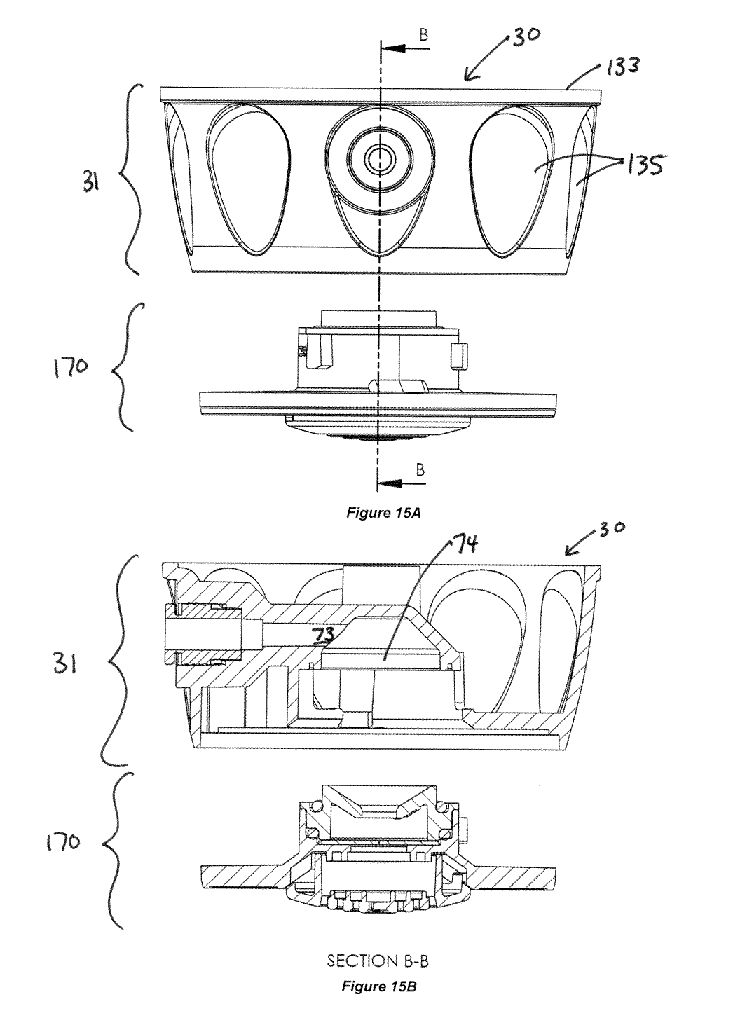

FIGS. 15A and 15B show yet another embodiment of the invention. To help with explanation, this embodiment is generally referred to as a surface mount sampling point assembly, whereas the embodiments shown in other figures are generally referred to as a panel mount sampling point assembly. FIGS. 15A and 15B each shows a side view and a cross-sectional view of an exemplary surface mount sampling point assembly in accordance with an aspect of the present invention.

A surface mount sampling point assembly 30, generally includes a sampling point body 31 which is to be mounted to a mounting structure e.g. a ceiling or wall panel or cabinet housing and the entire or at least a substantial part of the sampling point body 31 is exposed to the volume to be monitored. More preferably, the outlet 39 of the sampling point assembly 30, which is to be connected to a sampling conduit, is also exposed to the volume to be monitored. In comparison, a panel mount sampling assembly generally is mounted such that the sampling body extends through the mounting structure, and the outlet 39 that connects to a sampling conduit is generally on a side of the mounting structure that is not exposed to the volume to be monitored. Both types can include a removable cartridge 170 as described with reference to FIGS. 14 and 16.

The sampling point body 31 as shown in FIGS. 15A and 15B includes a generally cylindrical body portion 133. The sampling point body 31 includes an outlet 39 on a side surface of the cylindrical body portion 33. In use, the outlet 39 is connected to a sampling conduit 18 as mentioned above. In this example, the outlet has a fitting 40, e.g. a carstick cartridge, to enable convenient connection to a sampling conduit. The cross-sectional view of FIG. 15B illustrates the flow path through the sampling point body 31 beginning at the inlet 74, progressing into the hollow bore 73 within the cylindrical body portion 133 of the sampling point body 31, and continuing to the outlet 39.

The cylindrical body portion 133 may optionally include a series of generally water drop shaped cut outs 135 set about its periphery to improve the aesthetic appearances of the sampling point assembly 30. The sampling point body 31 is equipped with a suitable mounting mechanism allowing it to be fixed to the mounting structure. The mounting mechanism may be the same as what is described above with reference to FIGS. 8-13, or it can be one or more screws.

As can be seen from the above, embodiments of the present invention may provide a sampling point assembly that has one or more advantageous qualities. For example it may be quick to install and/or remove, and may be installed and/or removed from within the volume being sampled.

It will be understood that the invention disclosed and defined in this specification extends to all alternative combinations of two or more of the individual features mentioned or evident from the text or drawings. All of these different combinations constitute various alternative aspects of the invention.

1. A sampling point assembly for an aspirating particle detection system, the sampling point assembly being configured to be mounted to a mounting structure associated with a volume to be sampled, the sampling point assembly being further configured to be coupled to a conduit to deliver an air sample from the volume being sampled to the conduit, the sampling point assembling including:
a sampling point body having a bore running from an inlet at a first end of the bore to an outlet at a second end of the bore, said inlet being configured to be maintained in fluid communication with the volume being sampled to receive an air sample therethrough, and said outlet being configured to be coupled to the conduit such that the air sample can pass through the bore to the conduit; and
an elastomeric valve mounted to the sampling point body to determine the flow characteristics of sampling point.

2. A sampling point assembly as claimed in claim 1 wherein the valve is mounted outside the inlet, or within the bore.

3. A sampling point assembly as claimed in claim 2 wherein the valve abuts the inlet.

4. A sampling point assembly as claimed in claim 1 wherein the valve is held in place by a cap or other retaining structure.

5. A sampling point assembly as claimed in claim 1 wherein the elastomeric valve is carried in a removable cartridge.

6. A sampling point assembly as claimed in claim 5 wherein the cartridge also includes an orifice defining a flow restriction provided by the cartridge.

7. A sampling point assembly as claimed in claim 6 wherein orifice provides the inlet to the bore.

8-23. (canceled)

24. A sampling point assembly for an aspirating particle detection system, the sampling point assembly being configured to be mounted to a mounting structure associated with a volume to be sampled, the sampling point assembly being further configured to be coupled to a conduit to deliver an air sample from the volume being sampled to the conduit, the sampling point assembling including:
a sampling point body having a bore running from an inlet at a first end of the bore to an outlet at a second end of the bore, said inlet being configured to be maintained in fluid communication with the volume being sampled to receive an air sample therethrough, and said outlet being configured to be coupled to the conduit such that the air sample can pass through the bore to the conduit; and
a removable cartridge carrying an elastomeric valve mounted to the sampling point body.

25. A sampling point assembly as claimed in claim 24 wherein the cartridge also includes an orifice defining a flow restriction provided by the cartridge.

26. A sampling point assembly as claimed claim 24 wherein the cartridge is mounted so that it is readily removable from the sampling point body to enable it to be cleaned or replaced.

27. A sampling point assembly as claimed in claim 24 which further include a cap mounted with respect to the sampling point body such that it extends over the fastening mechanism to conceal the fastening mechanism from view from the first side of the mounting structure.

28. A sampling point assembly as claimed in claim 27 wherein the cap is removable to provide access to the fastening mechanism.

29. (canceled)

30. A sampling point assembly as claimed in claim 24 which further include a pipe connection fitting mounted at the outlet through which a sampling conduit can be connected to the sampling point body and be in fluid communication to the bore.

31. A sampling point assembly as claimed in claim 1 which include a fastening mechanism.

32. A sampling point assembly as claimed in claim 1 which is adapted to have its sampling point body mounted to a first side of a mounting structure associated with the volume to be sampled, wherein the first side being the side exposed to the volume to be sampled.

33. (canceled)

34. A removable cartridge for a sampling point assembly, said cartridge including:
an airflow path through the cartridge;
a mounting structure to enable the cartridge to be mounted to another component of a sampling point assembly, e.g. a sampling point body;
an elastomeric valve for controlling airflow through the cartridge.

35. A removable cartridge for a sampling point assembly as claimed in claim 34 wherein the cartridge also includes an orifice defining a flow restriction provided by the cartridge.

36. A removable cartridge for a sampling point assembly as claimed in claim 34 wherein the removable cartridge includes one or more of:
a cartridge body for carrying the elastomeric valve;
an orifice member through which the orifice passes; and
an outer cap component covering an inlet to the flow path through the removable cartridge.

37. A particle detection system including a:
at least one particle detector configured to analyze an air sample to detect the presence of particles of interest therein;
an air sampling network comprising at least one conduit along which sample air is delivered to the particle detector from the volume being monitored.
at least one sampling point assembly as claimed in claim 1, each sampling point assembly being connected to a respective conduit.

38. The particle detection system as claimed in claim 37, wherein the at least one particle detector is a smoke detector.
